(19) United States
(12) Patent Application Publication
(10) Pub. No.: US 2007/0247084 A1
(43) Pub. Date: Oct. 25, 2007

(54) Power supply based on resonant converter for lamp

(76) Inventor: Wei Zhao, Mckinney, TX (US)

Correspondence Address: Liang Chen, 5305 Hampshire Drive, Mckinney, TX, 75070, US

(21) Appl. No.: 11/351,625

(22) Filed: Feb. 11, 2006

(51) Int. Cl. H05B 37/02

(52) U.S. Cl. 315/291

(57) ABSTRACT

A power supply based on resonant converter with or without feedback is used for lamp. The output voltage waveform is high frequency (above 10 kHz) component included in a band envelope without low frequency component. Lamp brightness is proportional to lamp voltage. At low frequency (60 Hz), eye responds to brightness change by shrinking and dilating pupil and crystalline lens 60 times per second and become very tired after several hours. In the long run, the tiredness can cause eye muscles so slack that muscles can't control crystalline lens and pupil well. Thus myopia is caused and preexistent myopia will be deepened At high frequency (above 10 kHz), Eyes cannot keep pace with such high-speed brightness variation. High frequency will have no impact on people eyes muscle. It doesn't cause peoples eye tiredness. It prevents people's eyes from myopia or from myopia deepening for long run. It has dimming function.

### CROSS-REFERENCE TO RELATED APPLICATIONS

The present application claims priority to U.S. patent application Ser. No. 11/351,625 filed on Feb. 11, 2006, which is incorporated herein by reference in its entirety.

### BACKGROUND

The following disclosure relates to electrical circuits and signal processing.

Power supplies are used to power many types of electronic devices, for example, lamps. Conventional power supplies (e.g., for halogen lamps) typically include a converter. A converter is a power supply switching circuit.

Lamps have two categories:

First category uses ballast to strike the lamp to start. Most of them use gas to create light such as Fluorescent, HID, Compact, metal halide lamp etc. Bulbs need ballast because they use gas to create light. When the gas is excited by electricity, it emits invisible ultraviolet light that hits the white coating inside the bulb. The coating changes the ultraviolet light into light you can see. It needs a very high voltage strike to startup the operation of the lamp. But my invention is not applied directly to this category. The invention must be combined with second stage ballast to drive the lamp.

Second category doesn't need ballast to start the lamp. Most of them use heat generated by filament or diode etc to create light. Such as Halogen, Incandescent, LED, PAR lamp, miniature sealed beam lamp, Projection lamp, automotive lamp, some stage and studio lamp, DC fluorescent lamp etc.

My patent can be used directly on second category lamp.

Because Halogen lamp is the typical lamp of second category (filament or diode etc), all the discussion starts from the application of the power supply on Halogen lamp. For example, 20 W 12V Halogen Lamp, resistance=7.2 ohm at 12 volt; resistance=1.8 ohm at 2 volt.

FIG. 1 shows a conventional half bridge converter 100 that receives AC sinusoidal voltage from a power source Vin. Converter 100 includes transistors Q1, Q2, transformer T11, Coupled inductor T1A, T1B and T1C; DC blocking Capacitor C4, C5; Timing circuit C2, R2 and C3, R3; startup circuit D5, R4, Q3; R1, C1; bridge rectifier D1, D2, D3 and D4; AC power source 120 Vac 60 Hz sinusoidal (or 220 Vac 50 Hz) and Halogen lamp. (low voltage, for example 12 v)

Q1 and Q2 complementary on/off with 50% duty cycle. Output voltage waveform is 120 Hz low frequency envelope with high switching frequency square waveform in it. As shown in FIG. 2 and FIG. 3.

Vo=60*(4/3.14159)*ns/np (np is primary turns and ns is secondary turns.)

Dimming is realized by applying phase cut dimmer in the converter in trailing edge mode. This means that at the beginning of the line voltage half cycle, the switch inside the dimmer is closed and mains voltage is supplied to the converter allowing the converter to operate normally. At some point during the half cycle, the switch inside the dimmer is opened and voltage is no longer applied. The DC bus inside the converter almost immediately drops to 0 V and the output is no longer present. In this way, bursts of high frequency output voltage are applied to the lamp. The RMS voltage across the lamp will naturally vary depending on the phase angle at which the dimmer switch switches off. In this way the lamp brightness may easily be varied from zero to maximum output as shown in FIGS. 5 and 6.

Advantage:

This typical low-voltage halogen-lamp converter 100 is simple without IC controller.

Disadvantage:
1. Lamp brightness is proportional to the voltage on lamp. Output voltage has low frequency (120 Hz) envelope, voltage on lamp changes from valley to peak 120 times per second, so the brightness of lamp also changes from valley to peak 120 times per second. People eyes pupil will widen (mydriasis) when the brightness become dark and eyes pupil will contract when the brightness is bright (miosis). The eye muscles for controlling pupil and crystalline lens shrink and dilate 120 times per second and become very tired after reading books for several hours. In the long run, the tiredness can cause eye muscles slack and can't control crystalline lens and pupil well. Thus myopia is caused and preexistent myopia will be deepened.
2.Dimming needs external dimmer based on turn on/off line voltage. So cost increases.
3.Lamp filament behaves likes short circuit when low voltage apply on that. Inrush current during dimmer turn on/off input voltage at dimming is high and shortens the lamp life. Power factor is very low during dimming at low voltage.

FIG. 4 shows another way to drive the halogen lamp. A low frequency transformer is connected directly to the halogen lamp.

Advantage: Component is only one transformer and cost is less.

Disadvantage:

1.Output voltage has low frequency (60 Hz or 50 Hz) sinusoidal waveform, thus muscles to control eyes pupil and crystalline lens will shrink and dilate 60 or 50 times and feel tired. In the long run, the tiredness can cause eye muscles slack and can't control crystalline lens and pupil well. Thus myopia is caused and preexistent myopia will be deepened.
2.Variation output voltage for No Feedback;
3.Dimming needs external dimmer based on turn on/off line voltage, so the Power factor is very low during dimming, Inrush current during turn on is high and shorten the lamp life.
4.Transformer is too big and heavy for low frequency use.

### SUMMARY

In general, in one aspect, this specification describes new block diagram for Halogen lamp converter as FIGS. 7,8 and 9 as well as topology in FIGS. 12,13,14,15,19, 20,21,22 and 23.

Implementations can include one or more of the following advantages.
1.Output voltage is high frequency component in band envelope as shown in FIGS. 17,18,25 and 26. The high frequency is above 10 kHz. At that frequency, people eyes cannot keep pace with this high-speed brightness variation. High frequency will have no effect on people eyes muscle. There is almost no low frequency component or we can say low frequency component is trivia compared to FIG. 2. It doesn't cause peoples eye tiredness. It prevents people's eyes from myopia or from myopia deepening to maximum extent protection.
2.Output voltage can have feedback control or no feedback control.
3. Dimming is realized by changing switching frequency to change magnitude. No need for external dimmer and save cost. Dimming does not turn on/off input line voltage and does not cause inrush current. So lamp's life is prolonged.
4.Power factor correction circuit can be included or not included.
5.Input voltage source can be AC sinusoidal or DC substantially constant.

The details of one or more implementations are set forth in the accompanying drawings and the description below. Other features and advantages will be apparent from the description and drawings, and from the claims.

### DESCRIPTION OF DRAWINGS

FIG. 1: typical low-voltage halogen-lamp converter based on conventional half bridge converter 100.

FIG. 2: Output voltage waveform of typical halogen lamp converter 100 is high frequency square waveform contained in low frequency (120 Hz) envelope.
Top graph: Blue or red curve-rms voltage of output voltage; Red shade-output voltage Bottom table:
VP1-Peak value of output voltage=17 v; SQRT(AVG-rms value of output voltage.12 v

FIG. 3: Output high frequency square waveform in the low frequency envelope of typical halogen lamp converter 100.
Top: Red waveform-high frequency square waveform in output voltage
Bottom: rms value of output voltage

FIG. 4: The halogen lamp converter driven directly by a big low frequency transformer and output voltage on the lamp.

Top table:

V2-peak voltage value of output voltage = 16.9 v;
SQRT(AVG-rms value of output voltage = 12 v.
Top waveform: red-sinusoidal output voltage; blue-rms value of
output voltage
Bottom waveform: red-rms value of output voltage

FIG. 5: input bus voltage and lamp output voltage waveform during dimming with external dimmer for typical Halogen lamp converter 100.

| | |
|---|---|
| Left: trailing edge dimming | Right: Leading edge dimming |

FIG. 6: Output voltage and current during dimming of typical halogen lamp converter 100.

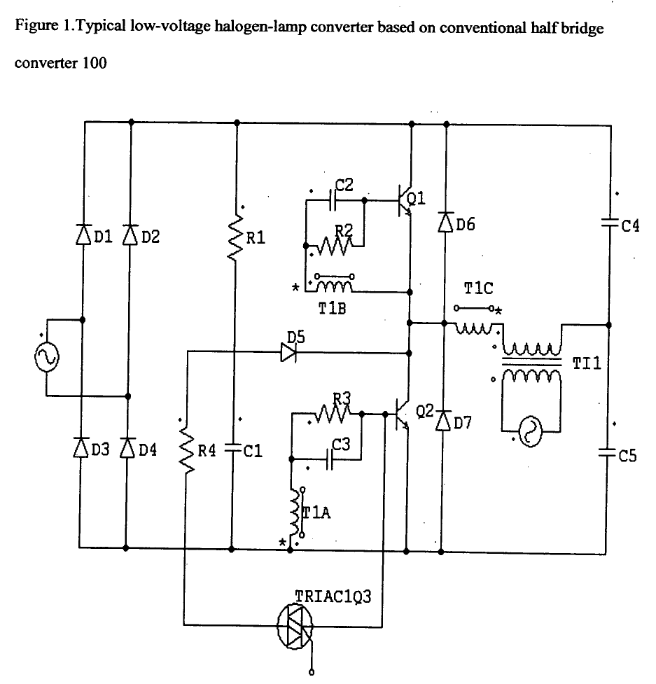

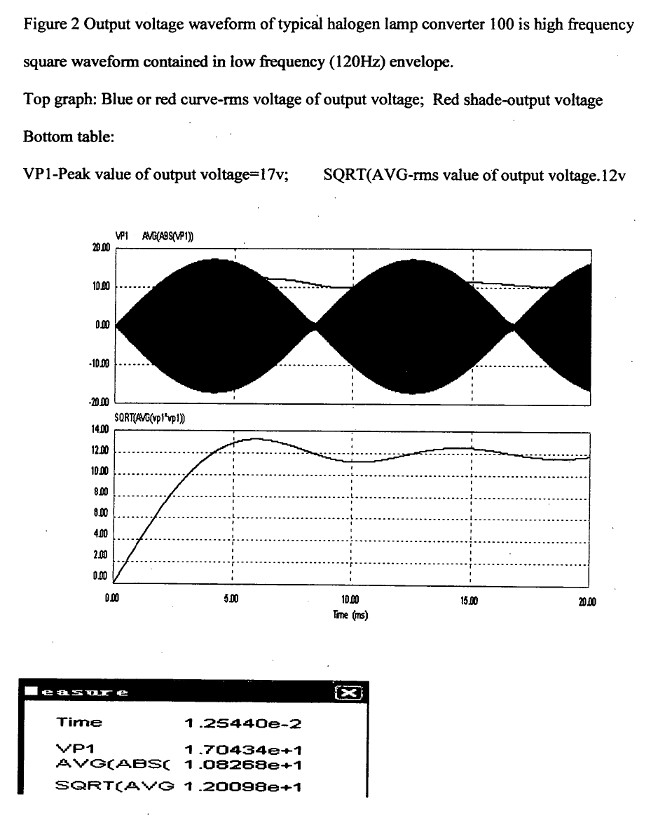

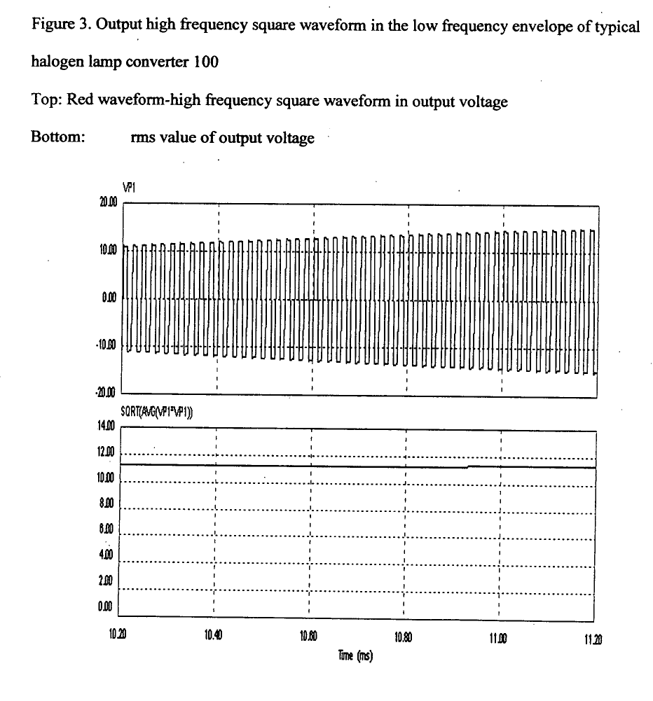

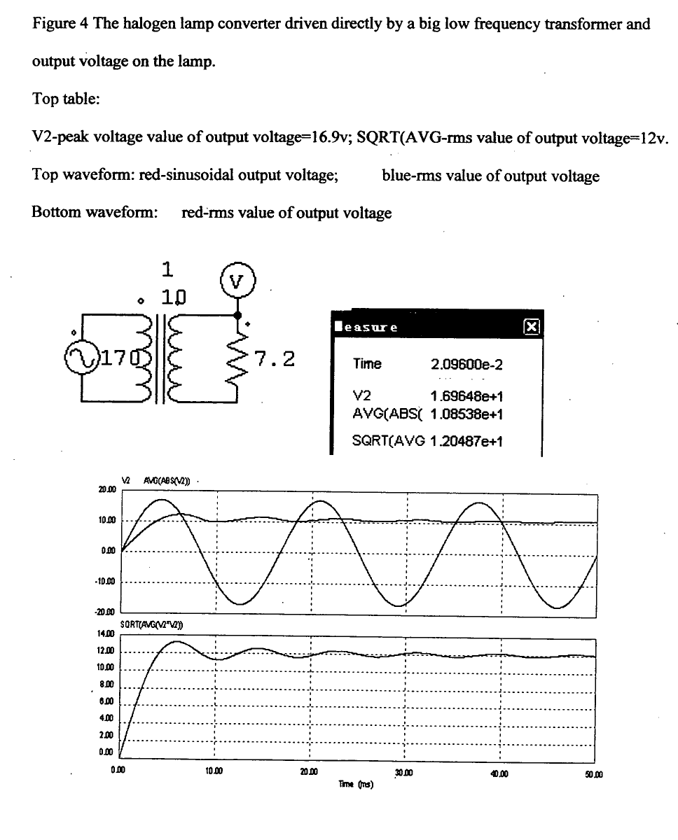

FIG. 7: Block diagram of my invention, Power Supply 200, power supply based on resonant converter for Lamp without feedback.
(a) Voltage source 210 comes from AC sinusoidal power line
(b) Voltage source 220 comes from DC substantially constant voltage

FIG. 8. Block diagram of my invention, Power Supply 200, power supply based on resonant converter for Lamp with feedback sampling signal coming from interior component in converter
(a) Voltage source 210 comes from AC sinusoidal power line
(b) Voltage source 220 comes from DC substantially constant voltage

FIG. 9. Block diagram of my invention, Power Supply 200, power supply based on resonant converter for Lamp with feedback sampling signal coming directly from lamp.
(a) Voltage source 210 comes from AC sinusoidal power line
(b) Voltage source 220 comes from DC substantially constant voltage

FIG. 10 Voltage waveform across B and B′ on block diagram FIGS. 7(a),8(a) and 9(a) when voltage source 210 comes from 120 volt AC sinusoidal line voltage.

FIG. 11. Voltage waveform across C and C′ on block diagram FIGS. 7(a),7(b), 8(a), 8(b), 9(a) and 9(b).

FIG. 12. Implementation 1 of power supply 200 for lamp:
Half-bridge secondary series resonant converter for converter 206 in FIG. 7
1.(1) Without feedback
(a) Power source V1 comes from AC sinusoidal power line
(b) Power source comes from DC constant voltage

FIG. 13. Implementation 1 of power supply 200 for lamp: Half-bridge secondary series resonant converter for converter 206 in FIG. 8
1.(2) With feedback (feedback signal comes from secondary of transformer coupled with lamp)
(a) Power source V1 comes from AC sinusoidal power line
(b) Power source VDC1 is DC constant voltage

FIG. 14. Implementation 1 of power supply 200 for lamp: Half-bridge secondary series resonant converter for converter 206 in FIG. 8
1.(3) With feedback (feedback signal comes from current sense resistor)
(a) Power source V1 comes from AC sinusoidal power line
(b) Power source VDC1 comes from DC constant voltage

FIG. 15. Implementation 1 of power supply 200 for lamp: Half-bridge secondary series resonant converter for converter 206 in FIG. 9
1.(4) with feedback (feedback signal comes directly from lamp)
   (a) Power source V1 comes from AC sinusoidal power line
   (b) Voltage source comes from DC constant voltage

FIG. 16 Lamp voltage rms value vs. switching frequency calculation for power supply 200 based on half bridge secondary series resonant converter of FIGS. 12,13,14 and 15.

FIG. 17. Normal operation output voltage waveform simulation and rms value measurement for circuit in FIGS. 12,13,14 and 15. (implementation 1 of power supply 200)
(In one implementation, lamp resistance=7.2 ohm at normal operation; switching frequency=60 kHz, C3=259 nf, L1=27 uh,turns ratio (primary:secondary)=5:1)

FIG. 18. Minimum dimming output voltage waveform simulation and rms value measurement for circuit in FIGS. 12,13, 14 and 15. (implementation 1 of power supply 200) (In one implementation, lamp resistance=1.8 ohm at minimum dimming; switching frequency=90 kHz, C3=259 nf, L1=27 uh,turns ratio (primary:secondary)=5:1)

FIG. 19. Implementation 2 of power supply 200 for lamp: Half-bridge primary series resonant converter for converter 206 in FIG. 7. 2.(1) without feedback
(a) Power source comes from AC sinusoidal power line
(b) Power source comes from DC constant voltage

FIG. 20. Implementation 2 of power supply 200 for lamp: Half-bridge primary series resonant converter for converter 206 in FIG. 8. 2.(2) with feedback (feedback signal comes from auxiliary winding coupled with lamp voltage)
(a) Voltage source comes from AC sinusoidal power line;
(b) Voltage source comes from DC constant voltage

FIG. 21. Implementation 2 of power supply 200 for lamp: Half-bridge primary series resonant converter for converter 206 in FIG. 8
2.(3) with feedback (feedback signal comes from current sense resistor)
(a) Power source VDC comes from AC sinusoidal power line
(b) Power source VDC comes from DC constant voltage

FIG. 22. Implementation 2 of power supply 200 for lamp: Half-bridge primary series resonant converter for converter 206 in FIG. 8
2.(4) with feedback (feedback signal comes from auxiliary winding coupled with lamp voltage and current sense resistor)
(a) Voltage source comes from AC sinusoidal power line
(b) Voltage source comes from DC constant voltage

FIG. 23. Implementation 2 of power supply 200 for lamp: Half-bridge primary series resonant converter for converter 206 in FIG. 9
2.(5) with feedback (feedback signal comes directly from lamp)
(a) Voltage source comes from AC sinusoidal power line
(b) Voltage source comes from DC constant voltage

FIG. 24. Lamp voltage rms value vs switching frequency calculation for power supply based on resonant converter of FIGS. 19,20,21,22 and 23. (implementation 2 of power supply 200)

FIG. 25. Normal operation output voltage waveform simulation and rms value measurement for circuit in FIGS. 19,20,21,22 and 23. (in one implementation, lamp resistance=7.2 ohm at normal operation; switching frequency=60 kHz, C3=8.3 nf, L1=847 uh, turns ratio (primary:secondary)=5:1)

FIG. 26. Minimum dimming output voltage waveform simulation and rms value measurement for circuit in FIGS. 19,20,21,22 and 23. (in one implementation, lamp resistance=1.8 ohm at minimum dimming operation; switching frequency=90 kHz, C3=8.3 nf, L1=847 uh, turns ratio (primary:secondary)=5:1)

### DETAILED DESCRIPTION

FIG. 7 is block diagrams of a power supply 200 for a connected output device. (e.g., lamp 211) without feedback; FIG. 8,9 are block diagram of a power supply 200 for a connected output device with feedback.

In one implementation (for example: power source is AC sinusoidal voltage from line), power supply 200 includes an RF1 201, an input filter 202, a rectifier 203, a resonant converter 206, a controller 209, dimmer 204, active startup circuit 208 and Lamp 211, feedback circuit 205, sample circuit 207 shown in FIGS. 7(a),8(a) and 9(a), power source 210 or 220.

In the other implementation, (for example: power source is DC substantially constant voltage ) RF1 201, an input filter 202, a rectifier 203 can be removed shown in FIGS. 7(b),8(b) and 9(b).

The power supply can have more blocks or fewer blocks than FIGS. 7, 8 and 9. (For example, 206,208,209 can be one integrated block or 208 can be removed in some implementation. Main switch of converter 206 or active startup circuit 208 can be integrated in the controller 209). The sequence and position of some blocks can be changed. (For example, position of 202 and 203 can be exchanged). Each block can use all kinds of different circuits with function as the following.

Voltage source 210 can be AC or DC. Voltage source 220 is DC. If voltage source is DC voltage, RF1 201, an input filter 202, a rectifier 203 can be removed. In one implementation, voltage source 210 is 60 Hz, 120 v sinusoidal AC voltage from power line. (Or 50 Hz, 220 v sinusoidal AC voltage from power line).

Input RF1 201 provides input current protection for converter 200. In particular, in one implementation, input fuse is designed to provide current protection for converter 206 by cutting off current flow to converter 206 in an event that current being drawn through input fuse 201 exceeds a predetermined design rating. In another implementation, RF1 201 is a flameproof, fusible, wire wound type and functions as a fuse, inrush current limiter. In another implementation, RF1 210 can be a NTC or PTC thermister.

Input filter 202 minimizes an effect of electromagnetic interference (EMI) on power supply 200, converter 206 and exterior power system. Input filter 202 can be LC filter π filter, common mode filter, differential mode filter or any type filter that provide a low impedance path for high-frequency noise to protect power supply 200 and exterior power system from EMI. Input filter 202 can be placed in front of rectifier 203 or behind rectifier 203.

Rectifier 203 converts the input AC source voltage from voltage source 210 (like FIG. 10) into DC voltage (like FIG. 11) when the blocking capacitor in converter 206 is large enough.

In one implementation, rectifier 203 is a full-wave rectifier that includes four rectifiers in a bridge configuration as in FIG. 12. In another implementation, rectifier 203 contains 2 diodes Rectifier can be any type or bridgeless PFC.

Resonant converter 206 converts the substantially DC constant voltage like FIG. 11 received from rectifier 203 into a band envelope contain high frequency component suitable to support an output device (e.g., halogen lamp 211).

Controller 209 is operable to regulate output voltage at predetermined value.

Controller 209 can be any type and have any type of control with PFC or without PFC function. (Such as digital control, analogy control, DSP, bang-bang control, skipping switching cycles and Pulse Train control etc.)

In such an implementation, controller 209 is operable to adjust the duty cycle, switching frequency or on time of main switch of converter 206 so that converter 206 outputs an AC high frequency component contained in band envelope having a predetermined rms voltage value. Controller 209 can control an output voltage level of converter 206 responsive to a predetermined value set by dimmer. In one implementation, dimmer can be a voltage divider and potentiometer. Controller 209 can have over current protection (current sense), over voltage protection, over temperature protection etc functions.

Normal operating; predetermined value set to rating voltage of lamp; dimming operating, predetermined value set to lower voltage than rating voltage of lamp.

Controller 209 can have feedback function or no feedback function. Feedback control voltage comes from feedback circuit 205, as discussed in greater detail below.

Sample 207 sense the signal proportional to output AC rms lamp voltage. It can come from lamp or other component in converter 206.

Dimmer 204 is operable to provide a dimming control voltage to controller 209 for dimming (or reducing) output voltage (e.g., halogen lamp 211). In one implementation, dimming voltage is realized by changing switching frequency (increase or decrease); In one implementation, dimming lamp is realized by changing potentiometer value and voltage divider ratio to change voltage reference for controller 209 in feedback.

In one implementation (non-isolated feedback), 204 can be realized by a resistor voltage divider (or zener diode and resistor voltage divider) and voltage cross one resistor goes to feedback pin of controller 209;

In one implementation (isolated feedback) 205 can be realized by a resistor voltage divider (or zener diode and resistor voltage divider) and voltage across one resistor or voltage across secondary winding is coupled to Feedback pin of controller 209 by auxiliary winding, opto-coupler or digital isolator etc

Feedback circuit 205 can have all kinds of different feedback way.

The feedback signal can come from transformer winding coupled with lamp output voltage for output voltage regulation as FIGS. 13 and 20, current sense resistor whose voltage is proportional to lamp rms current for output current regulation as FIGS. 14 and 21, or from both auxiliary winding and current sense resistor for output power feedback as FIG. 22. Or the feedback signal can come directly from lamp as FIGS. 15 and 23.

In real application, block can be more or less than FIGS. 7, 8 and 9. Some blocks may be different from FIGS. 7, 8 and 9.

A number of implementations are described as the following.

1.Implementation 1 of Power Supply 200 for Lamp Based on Half-Bridge Secondary Series Resonant Converter

In one implementation, we set fs=60 kHz during rating voltage operation (12 v) and fs=90 kHz during minimum dimming (2 v). For example, 20 W 12V Halogen Lamp, resistance=7.2 ohm at 12 volt; resistance=1.8 ohm at 2 volt. We use the area (inductance area) where switching frequency is greater than resonant frequency. We calculated and got C3=259 nF, L1=27 uH. Transformer turns ratio primary to secondary 5:1. C3 can select nearest standard value 270 nF. Inductor can be custom made with core and winding.

Of course if you select different frequency range or different operation area or even the same for normal operation or dimming, the value of C3 and L1 can be different.

This value is applied to FIGS. 12,13, 14 and 15.

Normal operation waveform simulation result is shown in FIG. 17 at fs=60 kHz, lamp resistance=7.2 ohm; Minimum dimming waveform simulation result is shown in FIG. 18 at fs=90 kHz, Lamp resistance=1.8 ohm. (Simulation software PSIM6.0)

1. (1) Without Feedback

FIG. 12 shows one implementation for the block diagram of FIG. 7. In real application, components can be more or less than FIG. 12.

In one implementation V1 is AC power line voltage, (120 v AC sinusoidal).

V1 functions as voltage source 210 in FIG. 7.

In another implementation, V1 is a constant DC voltage.

R3 is a fuse that functions as block 201 in block diagram FIG. 7.

L2, C4 function as filter 202 in FIG. 7.

D1, D2, D3 and D4 function as rectifier 203 in FIG. 7.

C5 behaves as a filter similar to 202 in FIG. 7.

Q1, Q2, C1, C2, T1, L1, R1 and C3 compose of a half bridge resonant converter that function as resonant converter 206 in FIG. 7. Q1 and Q2 are bipolar transistor or Mosfet. In one implementation, it is complementary turn on/off that is when Q1 turns on, Q2 turns off; when Q2 turns on, Q1 turns off; Meanwhile duty cycle is selected as close or equal to 50%. (In other implementation, duty cycle can select from 0% to 100% or transistor Q1 and Q2 do not complementarily turn on/off.) C1 and C2 are block and clamp capacitor with large value. C1 and C2 clamp the peak of AC voltage and block DC component. Thus the voltage across transformer primary almost equals to half of peak AC sinusoidal voltage in steady state.

In secondary of transformer T1, inductor L1, lamp resistance R1 and capacitor C3 compose of a series resonant converter.

R2 is current sense resistor to sense over current and shutdown the converter. In other implementation, R2 can be 0 ohm or short.

Calculation of lamp voltage VP1 is in FIG. 16.

The lamp output voltage waveform simulation at normal operating is shown in FIG. 17. Lamp resistance=7.2 ohm during rating voltage (for example 12 v). We can see the output voltage is high frequency sinusoidal waveform in a band envelope.

The lamp output voltage waveform at minimum dimming is shown in FIG. 18. It is high frequency triangular waveform in a band envelope. Both FIG. 17 and FIG. 18 have no low frequency component or we can see low frequency component is trivial compared to FIG. 2. So eyes will not adjust with low frequency flicker. It helps to prevent eyes from myopia.

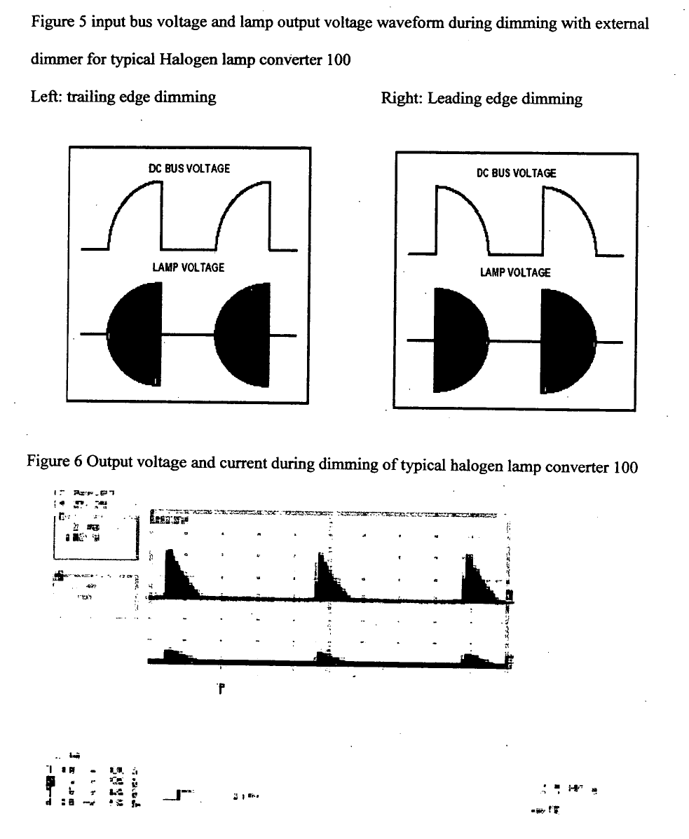

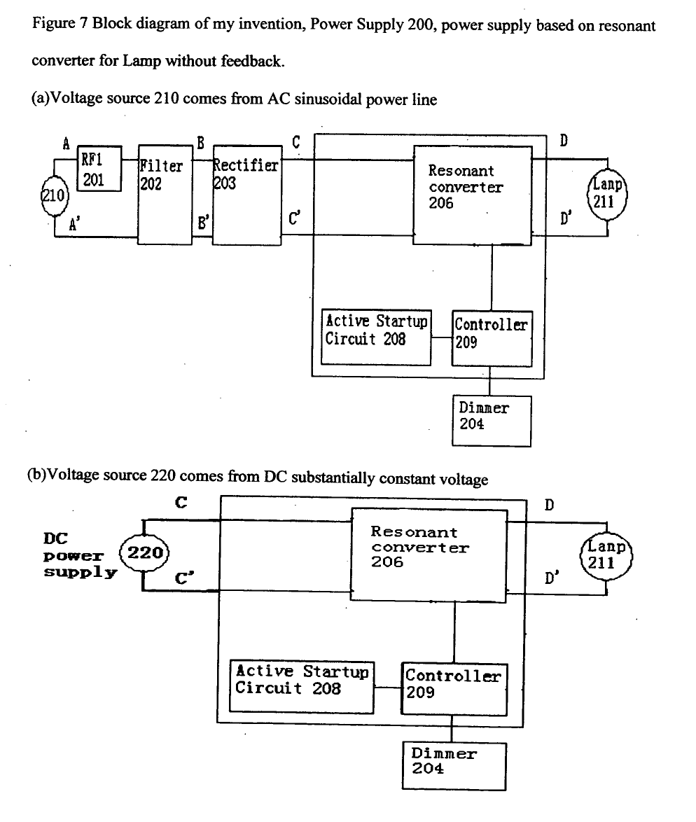

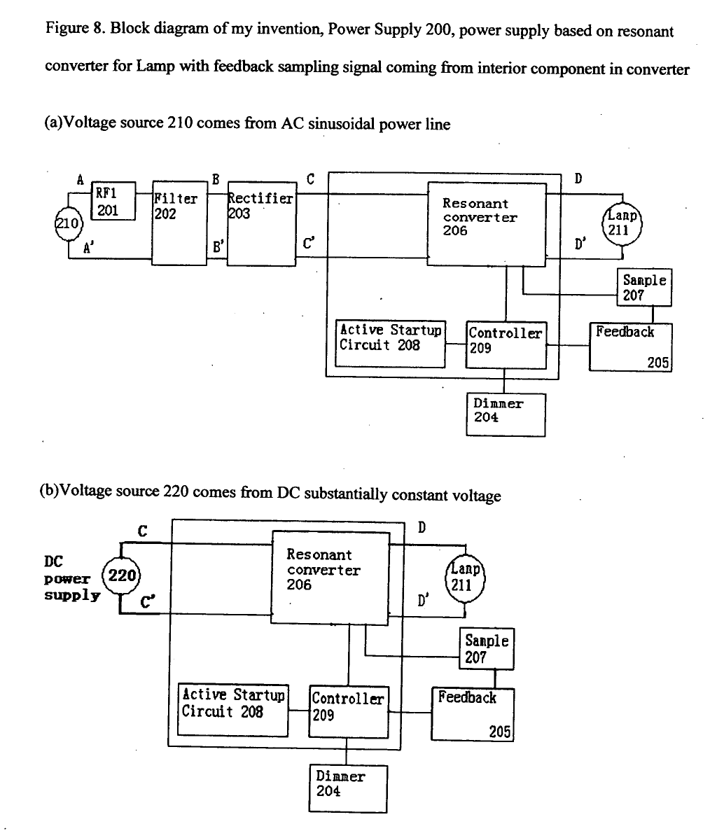

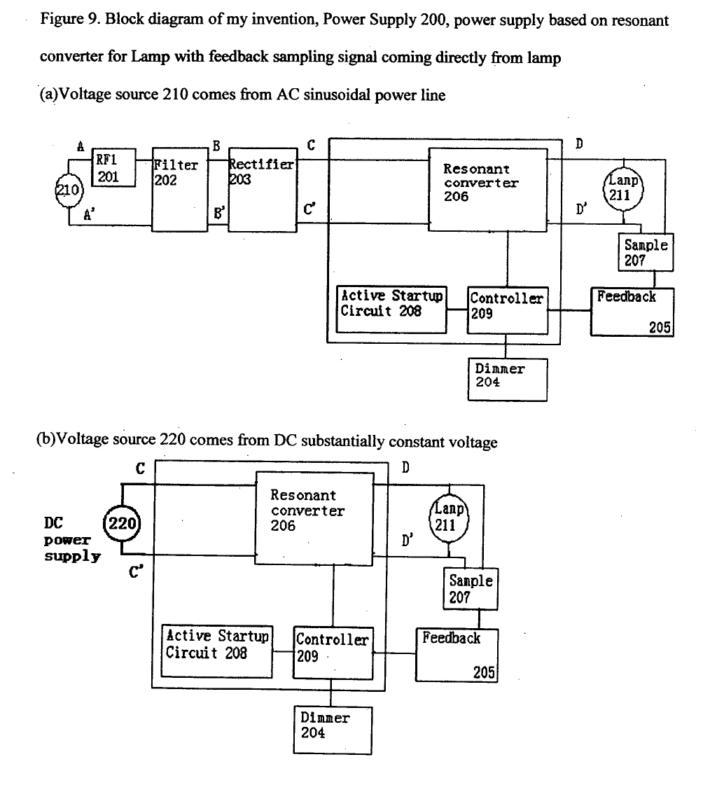

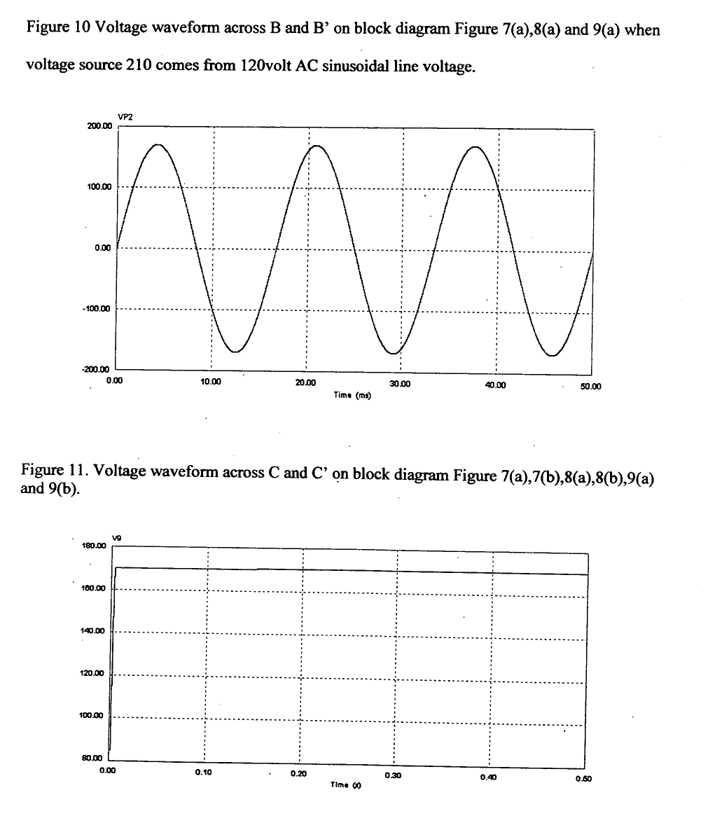

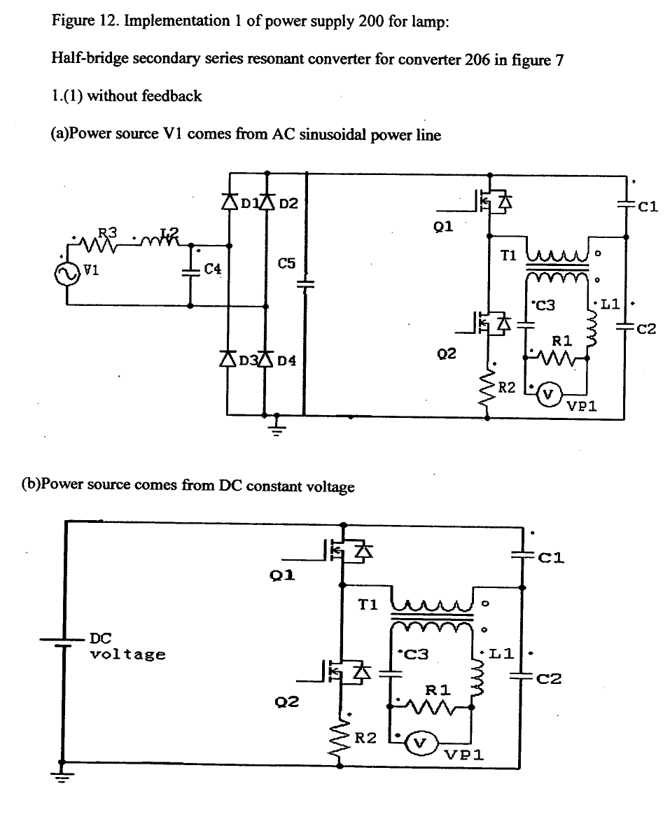

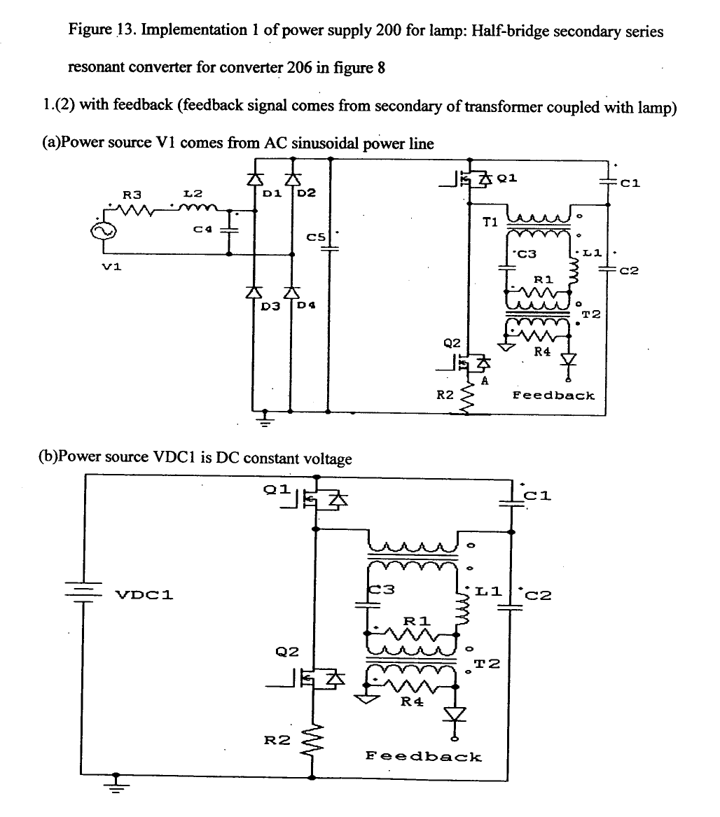

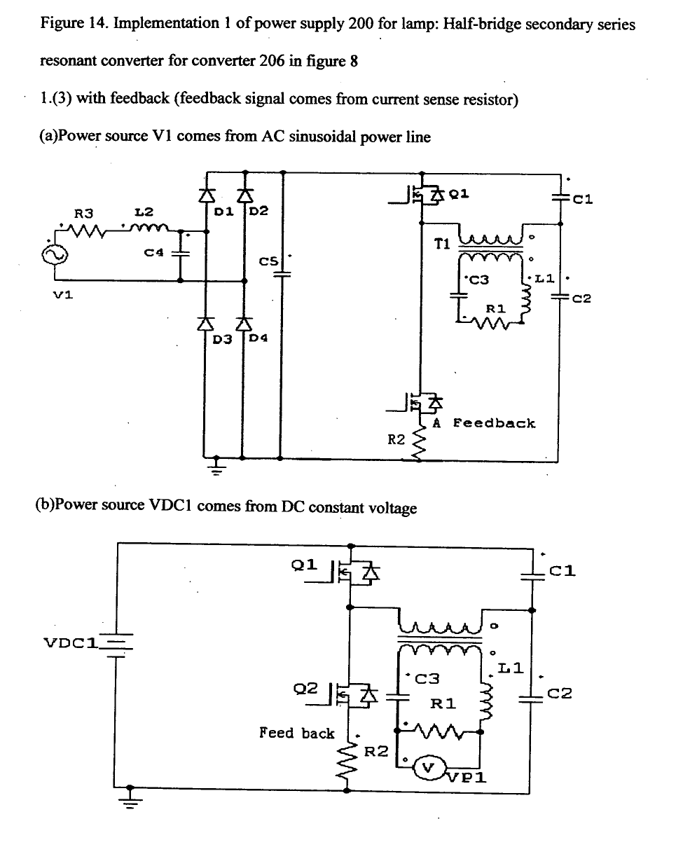

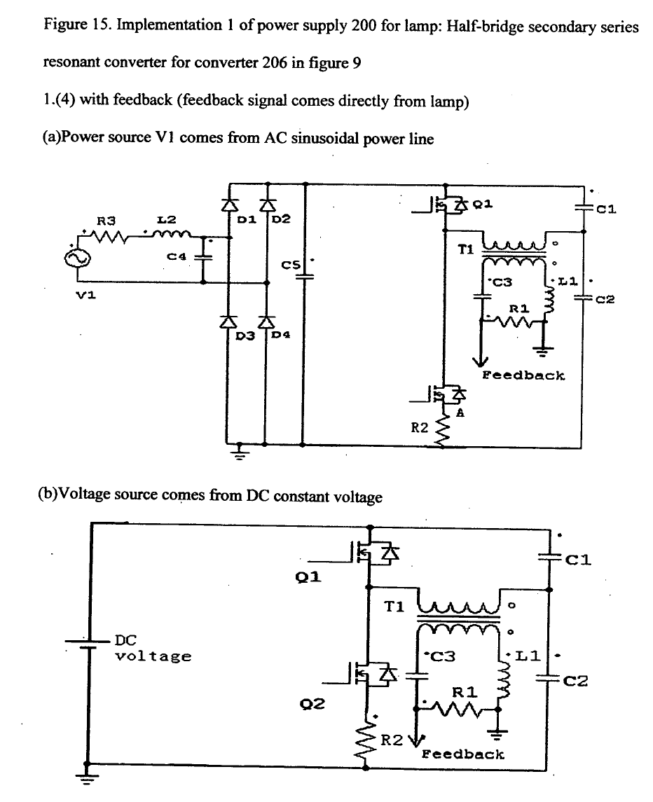

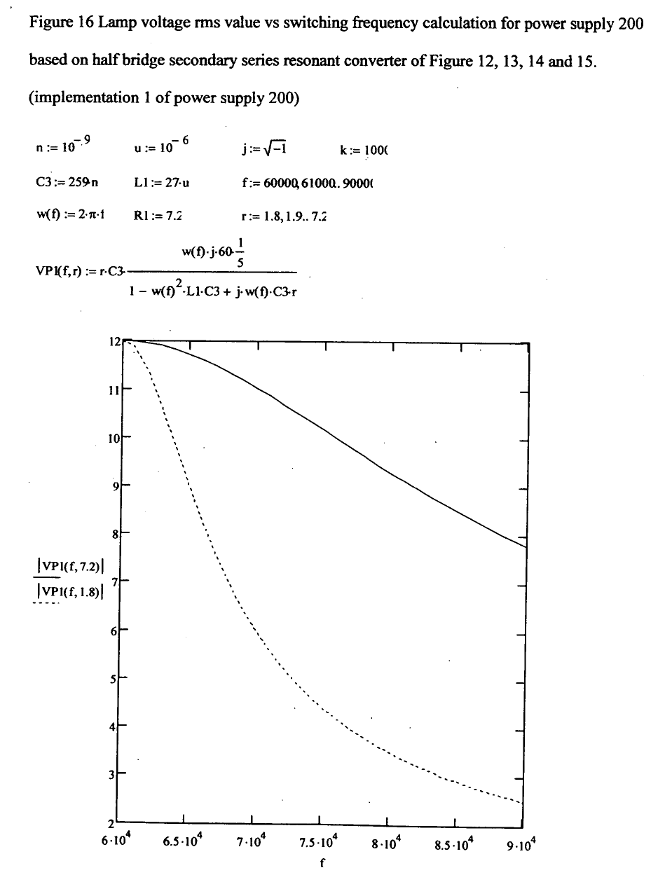

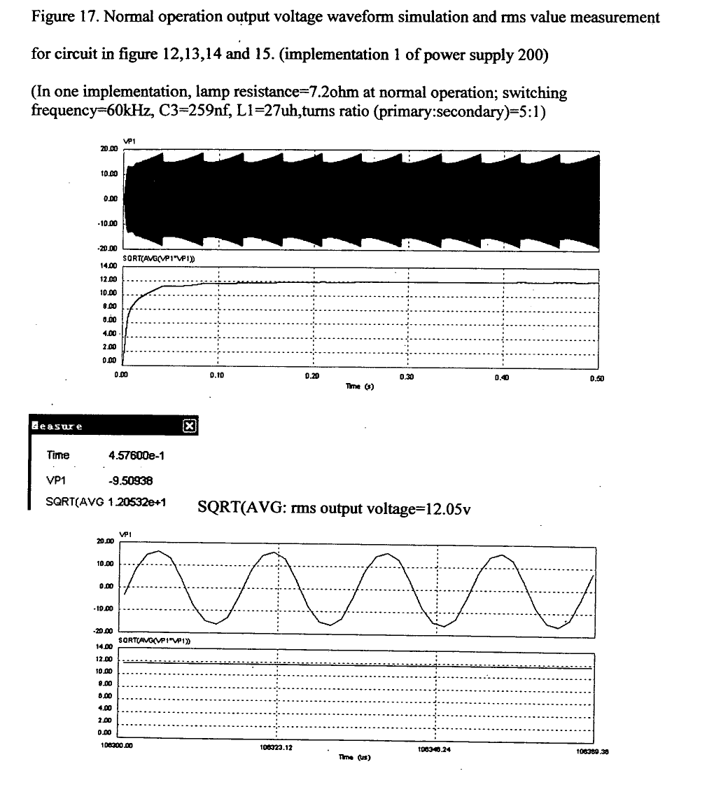

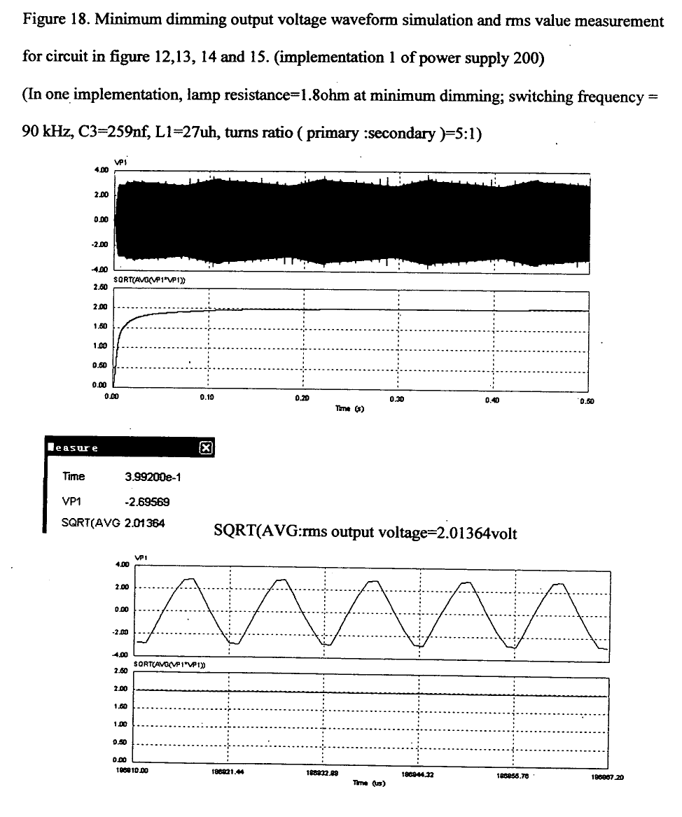

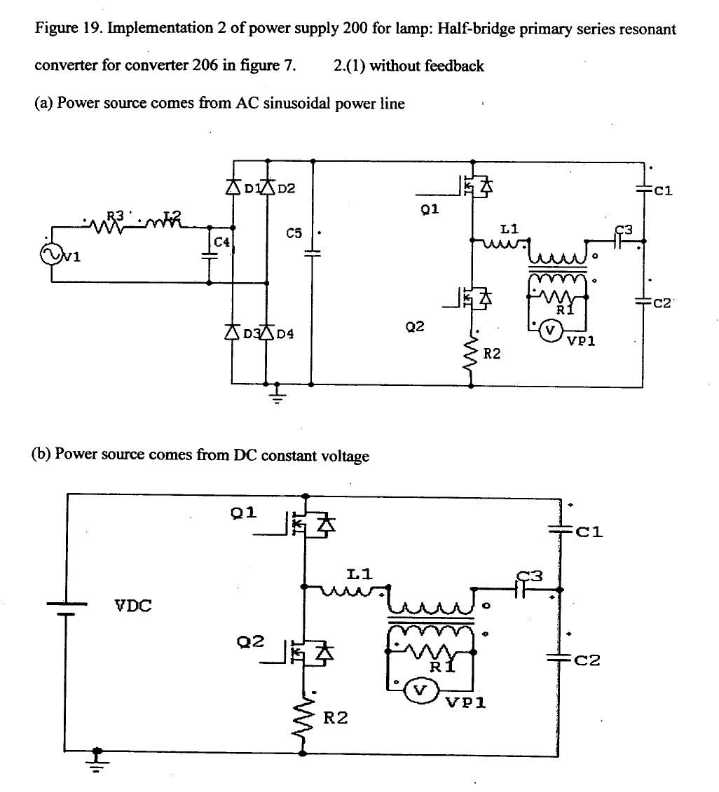

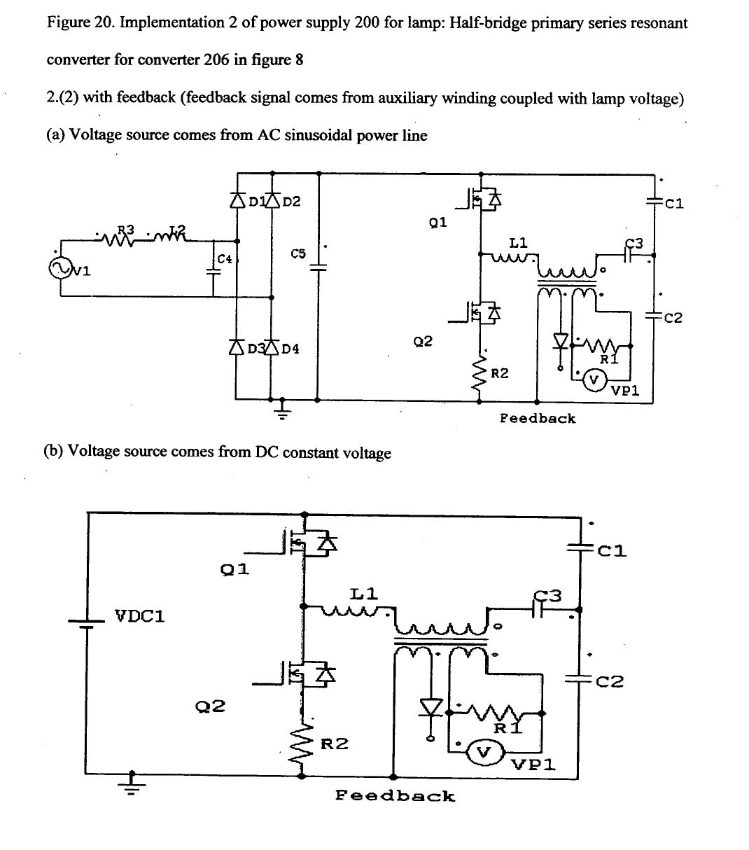

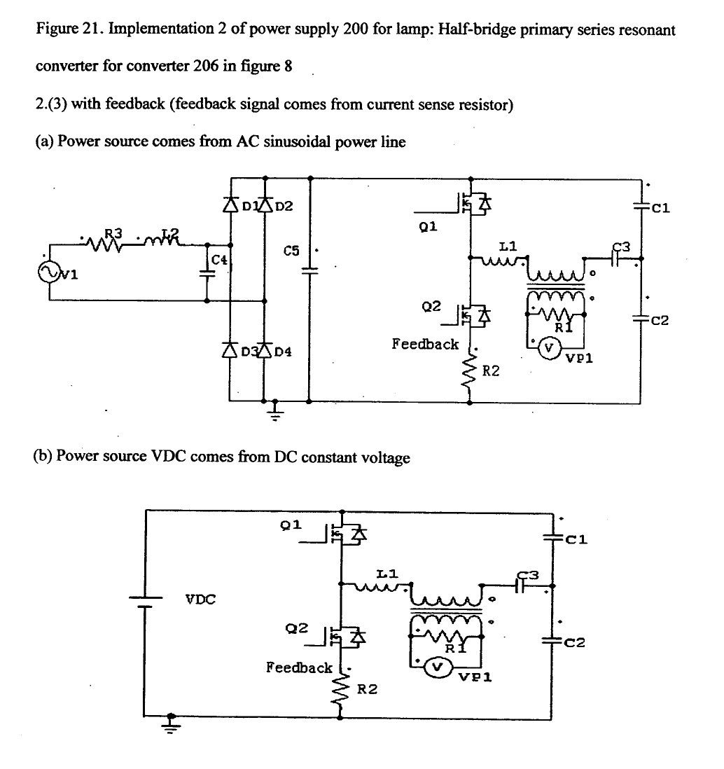

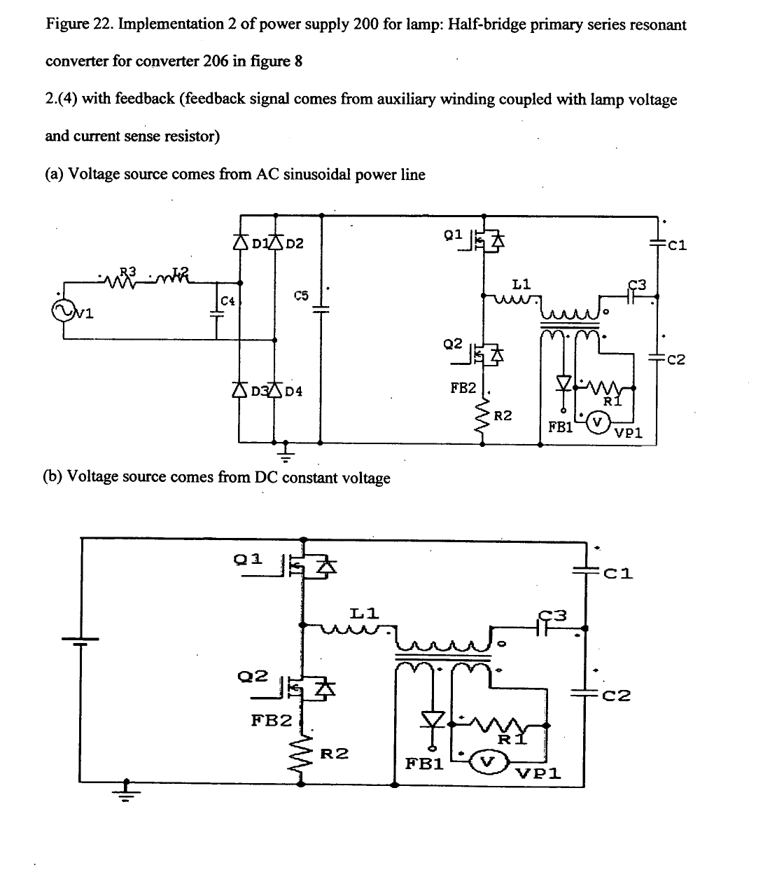

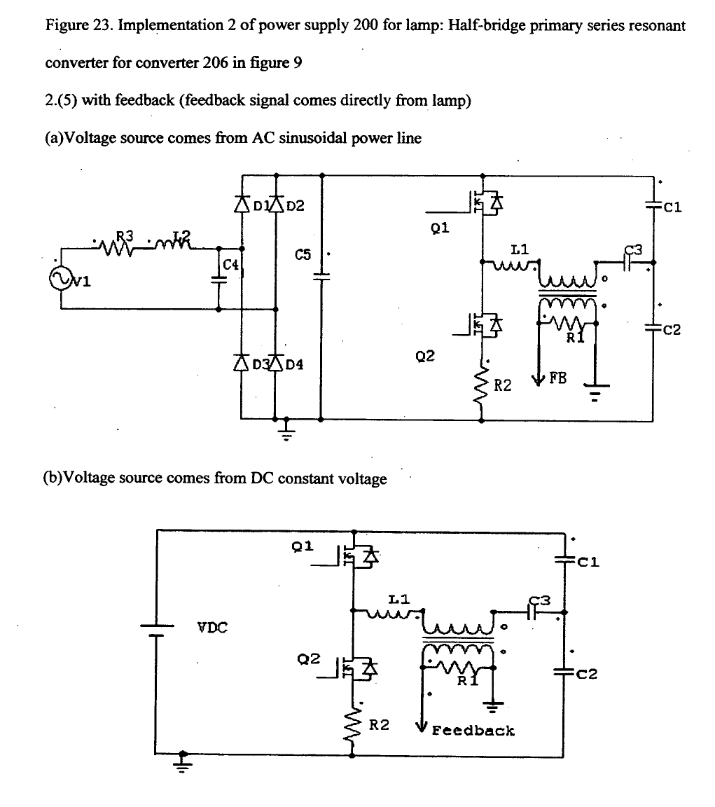

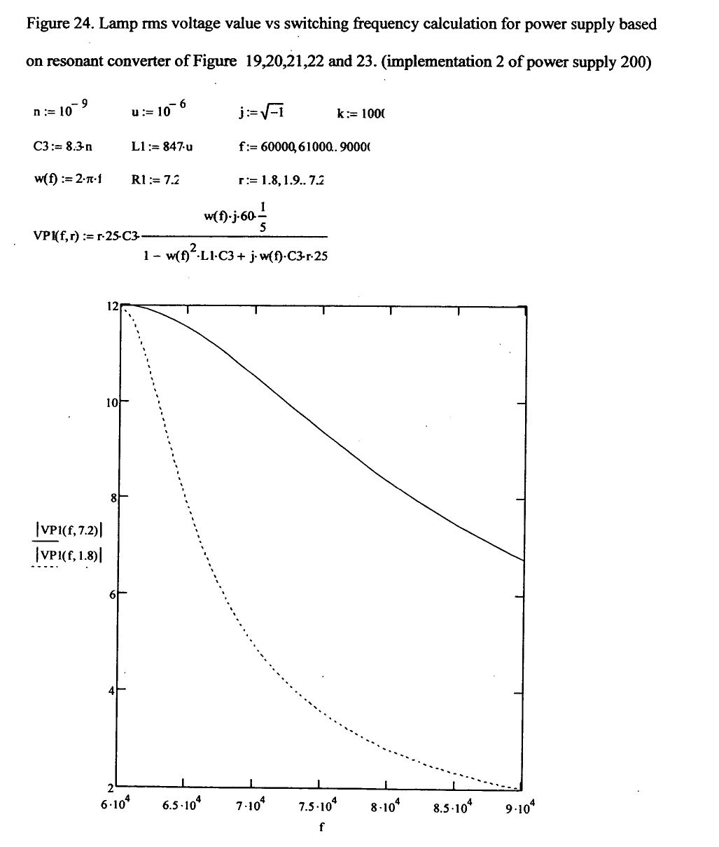

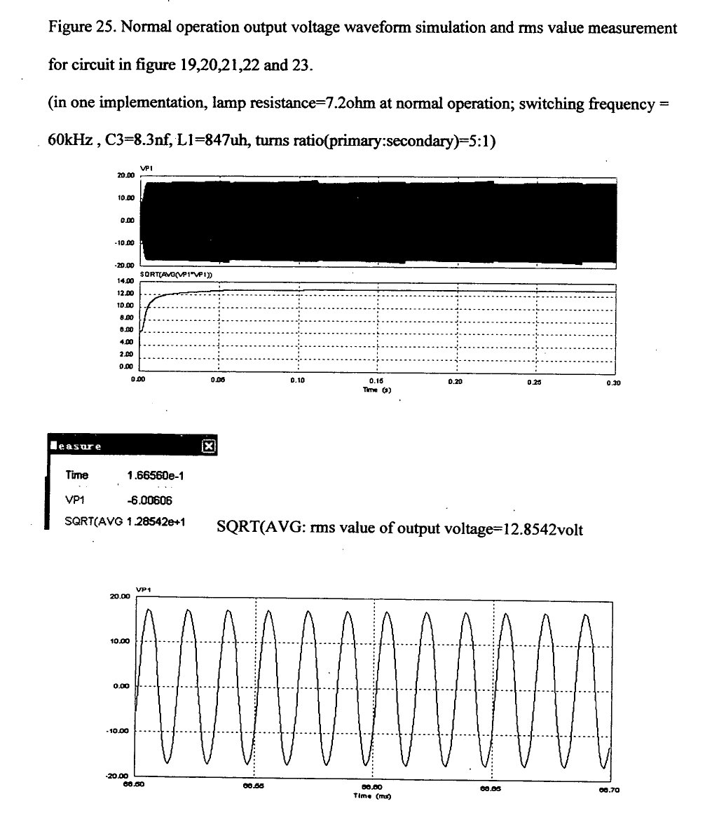

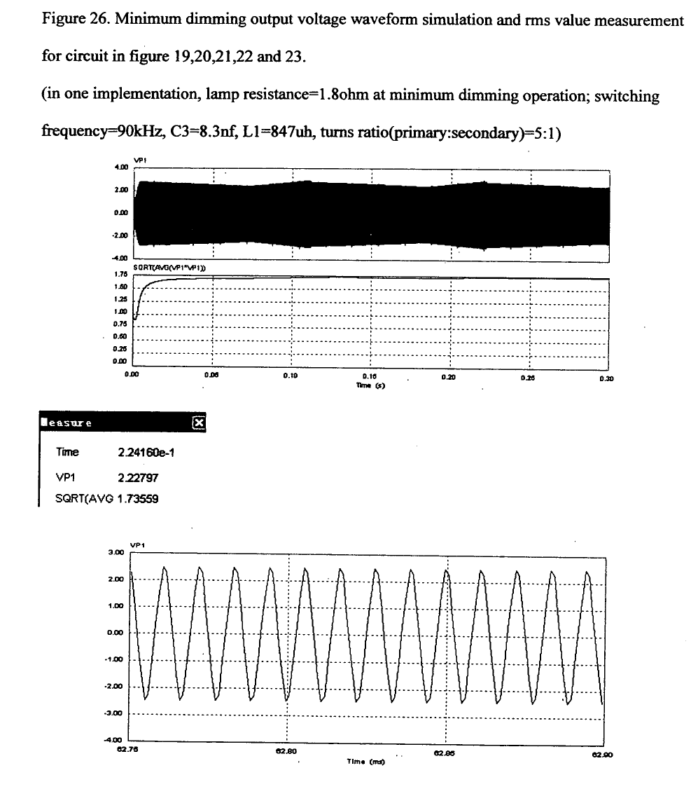

Dimming is realized by adjusting dimmer to change switching frequency. In one implementation, changes from 60 kHz for normal rating voltage to 90 kHz minimum dimming. Dimmer can be a potentiometer. Change potentiometer resistance value to change switching frequency of controller 209. Then the output voltage on lamp is decreased as shown in FIG. 16. The lamp voltage is a band including high frequency sinusoidal or triangular waveform. During dimming, the amplitude of the band envelope becomes smaller and smaller as dimming voltage goes down. My invention doesn't turn on/off input line voltage and has no inrush current compare with FIG. 5 and FIG. 6.

Advantage:

1. Lamp voltage in my invention doesn't include low frequency component. So eyes don't feel tiredness caused by low frequency component light flicker. Thus my invention helps to prevent people from myopia or prevent from myopia deepening.
2. My invention doesn't need external dimmer. My invention only needs changing frequency to realize dimming without feedback. So control is very simple and cost goes down.
3. My invention prolongs lamp's life for it doesn't turn on/off bus line voltage for dimming compared with traditional dimming waveform shown in FIGS. 5 and 6.
   1. (2) With Feedback (Feedback Signal Comes from Secondary of Transformer Coupled with Lamp)

FIG. 13 shows one implementation for the block diagram of FIG. 8. In real application, components can be more or less than FIG. 13.

Other components functions are the same as FIG. 12. The only difference is feedback transformer T2 and resistance R4. We can use opto-coupler, digital isolator to replace transformer T2. The lamp output voltage is coupled to secondary of T2. It passes voltage divider and goes to feedback pin of controller 209.

Controller 209 reads rms voltage of Feedback signal on feedback pin and compare with reference voltage set by dimmer.

In one implementation, if the feedback voltage is greater than reference voltage, switching frequency will be changed to decrease output voltage until output voltage equals to setting voltage set by dimmer. If the feedback voltage is less than reference voltage, switching frequency will be changed to increase output voltage until output voltage equal to setting voltage set by dimmer. In other implementation, the duty cycle and switching frequency can both be adjusted until output voltage equals to setting voltage

Advantage: Accurate voltage feedback and dimming

Disadvantage: One extra transformer T2 increases the cost

1. (3) Current Sense Feedback (Feedback Signal comes from Current Sense)

In FIG. 14, other components function the same as FIG. 12. Feedback can be realized by signal from current sense resistor R2. Reading rms voltage on R2 that is proportional to output current rms voltage and compare with reference voltage set by dimmer to set output current at predetermined level.

Advantage: Feedback with low cost and remove extra transformer T2.

Disadvantage: Need complex DSP algorithm or analog circuit to read rms voltage of R2 and accuracy is not as good as lamp voltage feedback.

1.(4) Feedback comes Directly from Lamp

FIG. 15 is similar to 1(2), the only difference is no coupled transformer. Lamp voltage is sent to feed back pin through voltage divider or rectifier. Controller reads the rms voltage or current to compare with reference set by dimmer. And voltage is regulated to predetermined rms voltage set by dimmer.

Advantage: Cost is minimum. Disadvantage: Primary and secondary has no isolation or limited isolation.

Feedback can also be realized by other methods.

As above, implementation 1(1), 1(2), 1(3), 1(4); all use secondary series resonant converter. The output voltage waveform at normal operation is shown in FIG. 17; the output voltage waveform at minimum dimming is shown in FIG. 18. In one implementation, C3=259 nF, L1=27 uH, Transformer turns ratio primary to secondary=5:1. The calculation of rms voltage vs. fs is shown in FIG. 16. When select different frequency range or different operation area (inductance area fs>f0 or capacitance area fs<f0) or even same frequency range and area for normal and dimming operation, C3 and L1 value and transformer turns ratio can be different from above value.

2.Implementation 2 of Power Supply 200 for Lamp Based on Primary Half Bridge Series-Resonant Isolated Converter

We set fs=60 kHz during rating voltage operation (12 v) and fs=90 kHz during minimum dimming (2 v). For example, 20 W 12V Halogen Lamp, resistance=7.2 ohm at 12 volt; resistance=1.8 ohm at 2 volt. We use the area (inductance area) where switching frequency is greater than resonant frequency. We calculated and got C3=8.3 nF, L1=847 uH, Transformer turns ratio primary to secondary 5:1. These values are applied to FIGS. 19,20,21,22 and 23. C3 can select nearest value; L1 can be custom made inductor with core and winding. When select different frequency range, C3 and L1 value and transformer ratio can be different from above value.

The calculation is shown in FIG. 24. Of course if you select different frequency range or different operation area or even the same for normal operation or dimming, the value of C3 and L1 can be different.

Normal operation waveform simulation result is shown in FIG. 25 at fs=60 kHz, lamp resistance=7.2 ohm; Minimum dimming waveform simulation result is shown in FIG. 26 at fs=90 kHz, Lamp resistance=1.8 ohm. (Simulation software PSIM6.0)

2. (1) Without Feedback

FIG. 19 shows one implementation for the block diagram of FIG. 7. In real application, components can be more or less than FIG. 19.

Other components functions are the same as FIG. 12. The only difference is C3, L1 are in primary with different values and lamp resistance is in secondary.

The output voltage waveform at normal operation is shown in FIG. 25; the deep dimming output voltage waveform at minimum dimming is shown in FIG. 26.

2. (2) With Voltage Feedback

As shown in FIG. 20, other components are the same as FIG. 19, Lamp voltage coupled on auxiliary winding and sensed by feedback pin of controller. Controller reads signal rms voltage that is proportional to lamp voltage and compares with reference voltage set by dimmer. If signal is greater than reference, that means output voltage is higher than predetermined value then switching frequency is changed to decrease output voltage until equal to predetermined value; If signal is less than reference, that means output voltage is lower than predetermined value then switching frequency is changed to increase output voltage until equal to predetermined value;

Advantage: Accurate feedback

Disadvantage: auxiliary winding add cost.

The output voltage waveform at normal operation is shown in FIG. 25; the deep dimming output voltage waveform at minimum dimming is shown in FIG. 26.

2. (3) Current Sense Feedback

As shown in FIG. 21, other components are the same as FIG. 20. Controller 209 reads current sense resistor signal rms voltage that is proportional to lamp voltage and compares with reference set by dimmer. If signal is greater than reference, that means output voltage is higher than predetermined value then switching frequency is changed to decrease output voltage until equals to predetermined value; If signal is less than reference, that means output voltage is lower than predetermined value then switching frequency is changed to increase output voltage until equal to predetermined value;

Advantage: Accurate feedback

Disadvantage: complex control algorithm, DSP or analog circuit to read rms.

The output voltage waveform at normal operation is shown in FIG. 25; the deep dimming output voltage waveform at minimum dimming is shown in FIG. 26.

2. (4) With Power Feedback

As shown in FIG. 22, other components are the same as in FIG. 19, Controller reads current sense resistor signal rms voltage that is proportional to lamp current and auxiliary winding coupled voltage that is proportional to output lamp voltage. The feedback voltage multiplies feedback current is feedback power. Then compares with reference set by dimmer. If signal is greater than reference, that means output power is higher than predetermined value then switching frequency is changed to decrease output power until equal to predetermined value; If signal is less than reference, that means output power is lower than predetermined value then switching frequency is changed to increase output power until equal to predetermined value;

Advantage: Accurate feedback

Disadvantage: complex control algorithm.

2. (5) With Feedback Directly from Lamp

As shown in FIG. 23, other components are the same as in FIG. 19. The only difference is no coupled transformer. Lamp voltage is sent to feed back pin through voltage divider or rectifier. Controller reads the rms voltage or current to compare with reference set by dimmer. If signal is greater than reference, that means output voltage is higher than predetermined value then switching frequency is changed to decrease output voltage until equal to predetermined value; If signal is less than reference, that means output voltage is lower than predetermined value then switching frequency is changed to increase output voltage until equal to predetermined value; And voltage is regulated to predetermined rms voltage set by dimmer.

A number of implementations have been described. Nevertheless, it will be understood that various modifications may be made without departing from the spirit and scope of the invention. In real application, blocks can be more or less than FIG. 7, 8 or 9. In real application, components can be more or less than FIG. 12,13,14,15,19,20,21,22 or 23. Moreover, the converter topologies discussed above can be used within power supplies to supply power to devices other than lamps.

What is clamed is:

1. A power supply based on resonant converter is for lamp.
Block diagram are shown in FIGS. 7, 8 and 9. In real application, the blocks can be more or less than FIG. 7, 8 or 9; the position and sequence of blocks can be changed.
There are two main categories of implementation:
(1) Power supply based on half-bridge secondary series resonant converter with series load as shown in FIGS. 12,13,14 and 15;
(2) Power supply based on half-bridge primary series resonant isolated converter with series load as shown in FIGS. 19,20,21,22 and 23.
Of course, converter 206 can use other resonant converter such as LLC resonant converter, LCC resonant converter, parallel resonant converter, series resonant converter with parallel load or other series resonant converter with series load etc to realize the waveform as claim 2.

2. In power supply of claim 1, the output lamp voltage waveform is high frequency sinusoidal or triangle waveform contained in band envelope as shown in FIGS. 17,18,25 and 26. This helps to prevent people's eyes from fatigue and protect people' eye sight to maximum.
Traditional power supply applied low frequency (60, 50, 120 or 100 Hz) sinusoidal voltage on lamp. Brightness of lamp is proportional to applied voltage magnitude. For example, higher voltage causes higher brightness on second category lamp of claim 3 (such as halogen lamp). That caused lamp brightness to change 60, 50, 120 or 100 times per second because 60 Hz, 50 Hz, 120 Hz or 100 Hz sinusoidal voltage will change magnitude 60, 50, 120 or 100 times per second. Eyes pupil will adjust 60, 50, 120 or 100 times per second. From brightness valley to brightness crest, the pupil will shrink (myosis); from brightness crest to brightness valley, the pupil will dilate (mydriasis). The eye muscles for controlling pupil and crystalline lens shrink and dilate 60, 50, 120 or 100 times per second and become very tired after several hours. In the long run, the tiredness can cause eye muscles slack and can't control crystalline lens and pupil well. Thus myopia is caused and preexistent myopia will be deepened.
The lamp output voltage in my invention is high frequency component contained in band. There is no low frequency component that causes people's eyes tired to become myopia. There is only high frequency (10 kHz above) brightness variation, pupil can not dilate and shrink in such a high speed. High frequency brightness has no effect on eyes muscles. So the power supply of my invention prevents people's eyes from tiredness; my invention prevents people's eyes from myopia to maximum extent; and my invention prevents people's eyes from deepening myopia to maximum extent.

3. The power supply of claim 1 can apply directly on second category lamp. Lamps have two categories as the following
First category uses ballast to strike the lamp to start. Most of them use gas to create light such as Fluorescent, HID, Compact, metal halide lamp etc. Bulbs need ballast because they use gas to create light. When the gas is excited by electricity, it emits invisible ultraviolet light that hits the white coating inside the bulb. The coating changes the ultraviolet light into light you can see. It needs a very high voltage strike to startup the operation of the lamp. But my invention is not applied directly to this category. The invention must be combined with second stage ballast to drive the lamp.
Second category doesn't need ballast to start the lamp. Most of them use heat generated by filament or diode etc to create light. Such as Halogen, Incandescent, LED, PAR lamp, miniature sealed beam lamp, Projection lamp, automotive lamp, some stage and studio lamp, DC fluorescent lamp etc. They can be used as Lamp 211.
My invention (power supply of claim 1) can be used directly on second category lamp.

4. In the power supply of claim 1, the dimming is realized by changing the switching frequency or duty cycle to change the voltage magnitude instead of turning on/off bus line as FIG. 5 and FIG. 6.
There is no on/off inrush current to stress lamp so that lamp's life is prolonged.
In one implementation, potentiometer is used to set reference voltage or to adjust switching frequency or duty cycle in order to regulate or change output voltage, output current or output power.

5. The power supply of claim 1 is comprising: (refer to FIG. 7,8,9)
In one implementation, power supply 200 includes an RF1 201, an input filter 202, a rectifier 203, a resonant converter 206, a controller 209, dimmer 204, active startup circuit 208 and Lamp 211, feedback circuit 205, sample circuit 207, voltage source 210 or 220. The power supply can have more blocks or fewer blocks than FIG. 7,8,9. (For example, 206,208,209 can be one integrated block or 208 can be removed in some implementation. Main switch of converter 206 and active startup circuit 208 can be integrated in the controller 209). The sequence and position of some blocks can be exchanged. (For example, position of 202 and 203 can be exchanged). Each block can use all kinds of different circuits with function as the following.

6. In power supply of claim 1, voltage source 210 or 220 can be AC or DC.
In one implementation, voltage source 210 is 60 Hz, 120 v sinusoidal AC voltage from power line. (or 50 Hz, 220 v sinusoidal AC voltage from power line).
If voltage source is DC voltage, RF1201, filter 202 or rectifier 203 can be removed shown in FIGS. 7(b),8(b) and 9(b). The DC voltage can come from a battery or PFC circuit in the first stage etc.

7. In power supply of claim 1, some blocks functions are as the following:
Input RF1 201 provides input current protection for converter 200. In particular, in one implementation, input fuse is designed to provide current protection for converter 206 by cutting off current flow to converter 206 in an event that current being drawn through input fuse 201 exceeds a predetermined design rating. In another implementation, RF1 201 is a flameproof, fusible, wire wound type and functions as a fuse, inrush current limiter. In another implementation, RF1 210 can be a NTC or PTC thermistor.
Input filter 202 minimizes an effect of electromagnetic interference (EMI) on power supply 200, converter 206 and exterior power system. Input filter 202 can be LC filter π filter, common mode filter, differential mode filter or any type filter that provide a low impedance path for high-frequency noise to protect power supply 200 and exterior power system from EMI. Input filter 202 can be placed in front of rectifier 203 or behind rectifier 203.
Rectifier 203 converts the input AC source voltage from voltage source 210 (like FIG. 10) into DC voltage (like FIG. 11) when the blocking capacitor in converter 206 is large enough. In one implementation, rectifier 203 is a full-wave rectifier that includes four rectifiers in a bridge configuration as in FIGS. 12 (a) and 13 (a). In another implementation, rectifier 203 contains 2 diodes Rectifier can be any type or bridgeless PFC.

8. In power supply of claim 1, Resonant converter 206 converts DC substantially constant voltage like FIG. 11 received from rectifier 203 into a band envelope containing high frequency component suitable to support an output device (e.g., halogen lamp 211). Resonant converter 206 can be secondary series resonant converter as FIGS. 12,13,14 and 15; Resonant converter 206 can be primary series resonant converter as FIGS. 19,20,21,22 and 23. Resonant converter 206 can use Flyback, Buck, Forward, Half-bridge, full bridge, push-pull, Cuk, SEPIC, Inverse of SEPIC, Boost, Buck-Boost, Noninverting buck-boost, Watkins-Johnson, Inverse of Watkins-Johnson, Current-fed, bridge etc

9. In power supply of claim 1, Controller 209 is operable to regulate output voltage at predetermined rms value.
Controller 209 can have any type of control with PFC or without PFC function. (Such as digital control, analogy control, DSP, μPFC , multiplier, bang-bang control, skipping switching cycles and Pulse Train control etc.) Controller 209 can be IC, microchip etc or discrete components.
In such an implementation, controller 209 is operable to adjust the duty cycle, switching frequency or on time of main switch of converter 206 so that converter 206 outputs an AC high frequency contained in band envelope having a predetermined rms voltage value set by dimmer. In one implementation, dimmer can be a voltage divider and potentiometer.
Controller 209 can have over current protection (current sense), over voltage protection, over temperature protection etc functions. Normal operating; predetermined value set to rating voltage of lamp; dimming operating, predetermined value set to lower voltage than rating voltage of lamp.
Controller 209 can have feedback function or no feedback function. Feedback control voltage comes from feedback circuit 205, as discussed in greater detail below.

10. In power supply of claim 1, sample 207 sense the signal proportional to output AC rms voltage, current or power. The signal can come from winding, current sense resistor or lamp voltage etc.

11. In power supply of claim 1, Dimmer 204 is operable to provide a dimming control voltage to controller 209 for dimming (or reducing) output voltage (e.g., halogen lamp 211). In one implementation, dimming lamp by changing potentiometer value to change voltage divider ratio (resistor and potentiometer compose the voltage divider). Duty cycle, switching frequency or on time of main switch are changed to change output rms voltage.
In one implementation (non-isolated feedback), 204 can be realized by a resistor voltage divider (or zener diode and resistor voltage divider) and voltage cross one resistor goes to feedback pin of controller 209;

12. In power supply of claim 1, we can set dimming value on dimmer 204 by sending wireless signal from control panel in a lighting system or by sending signal through power line.

13. In power supply of claim 1, Feedback circuit 205 can have all kinds of different feedback way.
The feedback signal can come from auxiliary winding coupled lamp output voltage for output voltage regulation as FIGS. 13 and 20; feedback signal can come from current sense resistor whose voltage is proportional to lamp rms current for output current regulation as FIGS. 14 and 21, or feedback signal come from both auxiliary winding and current sense resistor for output power feedback as FIG. 22. The feedback signal can come directly from lamp as FIGS. 15 and 23.
And the signal is sent to DSP, analog or digital circuit or digital algorithm in controller 209 to read the rms voltage value of signal. Then the rns signal value is compared with interior reference voltage to regulate voltage.
If rms signal value is larger than reference voltage set by dimmer, that means output rms voltage is larger than setting voltage, duty cycle or switching frequency is changed to cause output rms voltage to decrease until output rms voltage equals to setting rms voltage.
If rms signal value is less than reference voltage set by dimmer, that means output rms voltage is less than setting voltage, duty cycle or switching frequency is changed to cause output rms voltage to increase until output voltage equals to setting voltage.

14. In power supply of claim 1, rms current feedback is applied in FIGS. 14 and 21.
Feedback pin receives current sense resistor voltage signal that is proportional to output lamp rms current. And the signal is sent to DSP, analog or digital circuit or digital algorithm in controller 209 to read the rms value of signal. Then the rms signal value is compared with interior reference value set by dimmer to regulate rms current.
If rms signal value is larger than reference value set by dimmer, that means output rms current is larger than setting current, duty cycle or switching frequency is changed to cause rms output current to decrease until output current equals to setting rms value.
If rms signal value is less than reference voltage set by dimmer, that means output rms current is less than setting current, duty cycle or switching frequency is changed to cause output rms current to increase until output rms current equals to setting rms value.

15. In power supply of claim 1, rms power feedback is applied (for example: FIG. 22 or FIG. 14.) We can apply power feedback both in secondary series resonant converter (implementation 1) and in primary isolated series resonant converter.(implementation 2) Feedback pin receives current sense resistor voltage signal that is proportional to output lamp rms current and auxiliary winding voltage (or direct lamp voltage) that is proportional to output lamp voltage. And two signals are sent to DSP, analog or digital circuit or digital algorithm in controller 209 to read the rms value of power. Then the rms signal value is compared with interior reference power value set by dimmer to regulate power.
If rms signal value is larger than reference power value set by dimmer, that means output rms power is larger than setting power, duty cycle or switching frequency is changed to cause rms output power to decrease until output power equals to setting value.
If rms signal value is less than reference power value set by dimmer, that means output rms power is less than setting power value, duty cycle or switching frequency is changed to cause output rms power to increase until output power equals to setting value.

16. In power supply of claim 1, active startup circuit 208 can be valley-filled circuit, linear regulator or auxiliary winding etc.

17. In power supply of claim 1, in one implementation, the main switch can be integrated in the controller. Other circuit or block can be integrated into IC controller such as active startup circuit 208.

18. In power supply of claim 1, for different operation area (fs>f0 inductance area or fs<f0 capacitance area; fs switching frequency, fo resonant frequency)or for different frequency range other than 60 kHz to 90 kHz (normal operation switching frequency to deep dimming switching frequency), inductor, Capacitor value or transformer turns ratio can be different from the value in FIG. 12,13,14,15,19,20,21,22 or 23 etc. Even for same frequency range from 60 kHz to 90 kHz and same operation area, inductor, capacitor value and transformer turns ratio can be different from the value in FIG. 12,13,14,15,19,20,21,22 or 23 etc.

19. The power supply of claim 1 based on resonant converter is not used only for lamp. It can also be used for other device.

20. The power supply of claim 1 can have more or less components than FIG. 12,13,14,15,19,20,21,22 or 23 etc. The power supply of claim 1 can have different components values from FIG. 12,13,14,15,19,20,21,22,23 etc
